(19) United States
(12) Patent Application Publication
(10) Pub. No.: US 2026/0065922 A1
(43) Pub. Date: Mar. 5, 2026

(54) MODEL FOR SPEECH ENHANCEMENT

(71) Applicant: Nokia Technologies Oy, Espoo (FI)

(72) Inventors: Konstantinos DROSOS, Espoo (FI); Mikko Olavi HEIKKINEN, Tampere (FI); Juha Tapio VILKAMO, Espoo (FI); Paschalis TSIAFLAKIS, Antwerp (BE)

(21) Appl. No.: 19/300,938

(22) Filed: Aug. 15, 2025

(30) Foreign Application Priority Data
Aug. 29, 2024 (FI) 20246071

(51) Int. Cl. G10L 21/0216; G06N 3/044; G06N 3/0455; G10L 25/30

(52) U.S. Cl. CPC G10L 21/0216; G06N 3/044; G06N 3/0455; G10L 25/30

(57) ABSTRACT

Examples of the disclosure relate to a model that can be used for speech enhancement. The model comprises an encoder part comprising a sequence of encoding layers and caused to receive input data. The input data is based on a current frame of a noisy speech signal and one or more past frames of the noisy speech signal. The sequence of encoding layers is caused to process the input data so that output data of the encoder part comprises a reduced number of the multiple frequency positions and a single temporal position. The model also comprises a decoder part comprising a sequence of decoding layers caused to receive data from a prior decoding layer. The output data of the decoder part comprises multiple frequency positions and a single temporal position. The output data of the decoder part is for post processing to provide an output signal for speech enhancement.

### TECHNOLOGICAL FIELD

Examples of the disclosure relate to a model for speech enhancement. Some relate to a model based on neural networks that can be used for speech enhancement.

### BACKGROUND

Audio communication systems can be used to transmit audio signals between respective users. Audio enhancement can be used in such systems to improve the intelligibility of speech within the audio.

### BRIEF SUMMARY

According to various, but not necessarily all, examples of the disclosure there is provided a model for speech enhancement comprising:
an encoder part comprising a sequence of encoding layers wherein the encoder part is caused to receive input data where the input data is based on a current frame of a noisy speech signal and one or more past frames of the noisy speech signal and the input data comprises data elements corresponding to multiple frequency positions and multiple temporal positions, wherein the sequence of encoding layers is caused to process the input data so that output data of the encoder part comprises a reduced number of the multiple frequency positions and a single temporal position;
a decoder part comprising a sequence of decoding layers caused to receive data from a prior decoding layer, wherein at least one of the decoding layers is caused to receive data from a prior decoding layer and an encoding layer, and wherein the sequence of decoding layers is caused to process the received data so that the output data of the decoder part comprises multiple frequency positions and a single temporal position; and
wherein the output data of the decoder part is for post processing to provide an output signal for speech enhancement.

The model may comprise one or more skip connections caused to relay skip connection signals from respective encoding layers to corresponding decoding layers to enable at least one of the decoding layers to receive data from a respective encoding layer.

The skip connection signals may comprise a single temporal position.

The decoding layers of the decoder part may comprise operations to combine data from a skip connection signal with received data from a prior decoding layer and operations to increase the multiple frequency positions of the combined data.

The decoding layers of the decoder part may comprise operations to combine data from a skip connection signal with received data from a prior decoding layer and a linear interpolation process and operations caused to increase the frequency positions of the combined data.

The sequence of decoding layers may be caused to process the received data so that the output data of the decoder part comprises the same number of frequency positions as the input data for the encoder part and a single temporal position.

The encoding layers of the encoder part may comprise convolutional operations.

At least one of the encoding layers may use a kernel comprising multiple temporal components to process data elements corresponding to more than one temporal position.

At least one of the encoding layers may use a kernel that uses dilation in a temporal dimension.

The model may comprise an input layer caused to generate the input data based on the current frame and to store the input data based on past frames.

The model may comprise a bottleneck comprising one or more layers caused to process the output data of the encoder part into bottleneck output data that comprises a single temporal position; and the decoder part is configured to receive and process the bottleneck output data.

The bottleneck may comprise a recurrent neural network layer.

The post processing may be performed by a post processing part and wherein the post processing part is one of:
part of the model; or
outside of the model.

The post processing part may comprise one or more layers caused to process the output data of the decoder part to provide an output signal for the speech enhancement.

The post processing part may comprise a recurrent layer caused to process the output data of the decoder part to provide at least one of an output mask for the speech enhancement or an enhanced speech signal.

The speech enhancement may comprise at least one of:
denoising;
echo suppression;
de-reverberation;
speech bandwidth expansion;
packet loss concealment improvement;
wind noise removal;
recovery of missing speech signal;
residual echo suppression;
jet engine noise removal; or
non-linear distortion removal.

According to various, but not necessarily all, examples of the disclosure there is provided an apparatus comprising means for executing the model as claimed in any preceding claim.

According to various, but not necessarily all, examples of the disclosure there is provided a method comprising:
receiving input data where the input data is based on a current frame of a noisy speech signal and one or more past frames of a noisy speech signal and the input data comprises data elements corresponding to multiple frequency positions and multiple temporal positions;
encoding the input data using a sequence of encoding layers to provide output data of the encoding comprising a reduced number of frequency positions and a single temporal position;
decoding the output data of the encoding using a sequence of decoding layers caused to receive data from a prior decoding layer, wherein at least one of the decoding layers is configured to receive data from a prior decoding layer and an encoding layer, to provide output data of the decoding, and wherein the output data of the decoding comprises multiple frequency positions and a single temporal position; and
processing the output data of the decoding to provide an output signal for speech enhancement.

According to various, but not necessarily all, examples of the disclosure there is provided a computer program comprising instruction which, when executed by a processor, cause the processor to perform:
receiving input data where the input data is based on a current frame of a noisy speech signal and one or more past frames of a noisy speech signal and the input data comprises data elements corresponding to multiple frequency positions and multiple temporal positions;
encoding the input data using a sequence of encoding layers to provide output data of the encoding comprising a reduced number of frequency positions and a single temporal position;
decoding the output data of the encoding using a sequence of decoding layers configured to receive data from a prior decoding layer, wherein at least one of the decoding layers is configured to receive data from a prior decoding layer and an encoding layer, to provide output data of the decoding, and wherein the output data of the decoder part comprises multiple frequency positions and a single temporal position; and
processing the output data of the decoding to provide an output signal for speech enhancement.

According to various, but not necessarily all, embodiments there is provided an apparatus comprising:
at least one processor; and
at least one memory including computer program code;
the at least one memory storing instructions that, when executed by the at least one processor, cause the apparatus to perform at least a part of one or more methods described herein.

According to various, but not necessarily all, embodiments there is provided an apparatus comprising means for performing at least part of one or more methods described herein.

The description of a function and/or action should additionally be considered to also disclose any means suitable for performing that function and/or action. Functions and/or actions described herein can be performed in any suitable way using any suitable method.

According to various, but not necessarily all, embodiments there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate.

The description of a function should additionally be considered to also disclose any means suitable for performing that function.

### BRIEF DESCRIPTION

Some examples will now be described with reference to the accompanying drawings in which:

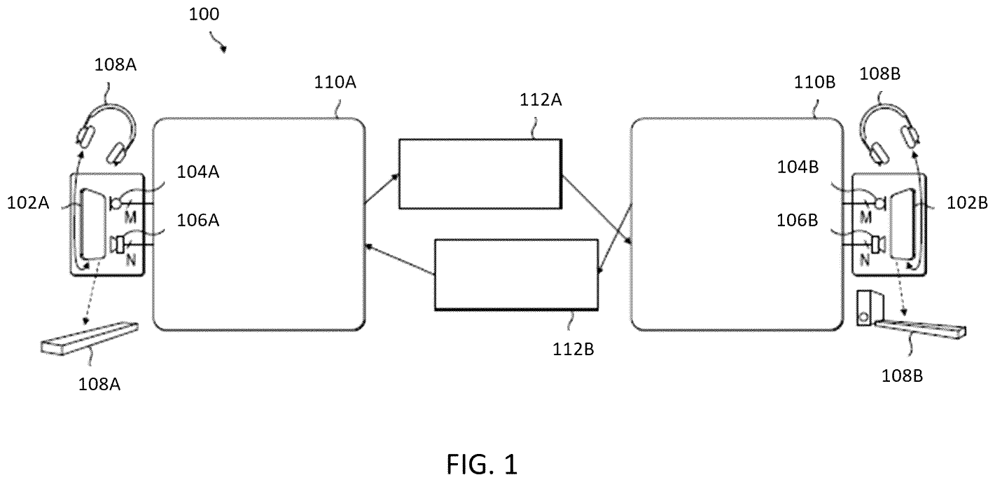

FIG. 1 shows a system;

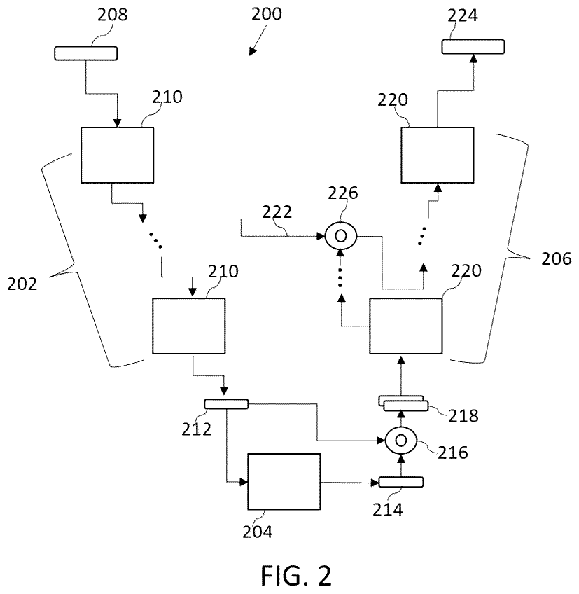

FIG. 2 shows a UNet architecture;

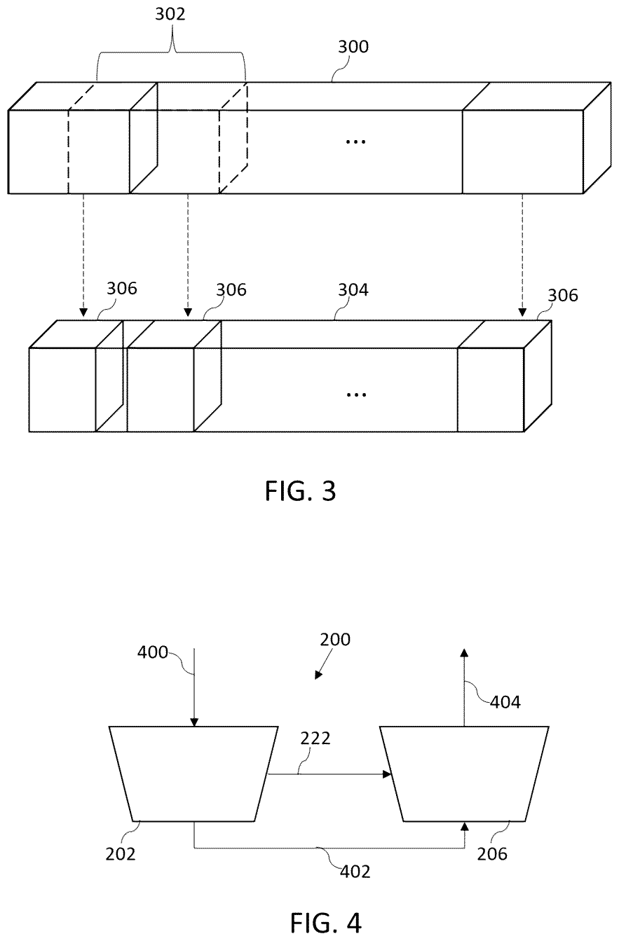

FIG. 3 shows a kernel processing a frame of data;

FIG. 4 shows an example model;

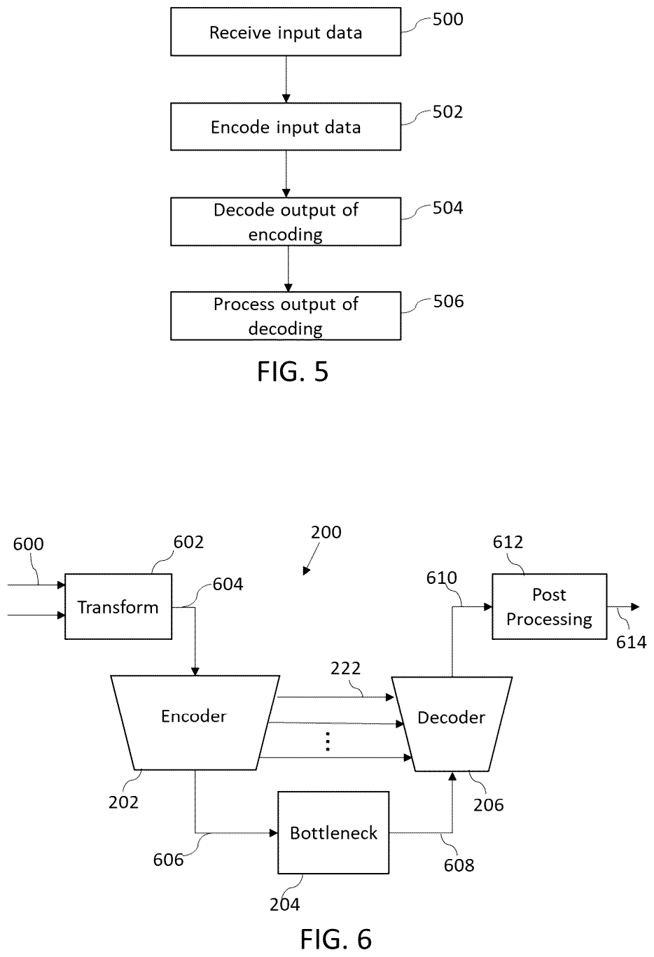

FIG. 5 shows an example method;

FIG. 6 shows an example model;

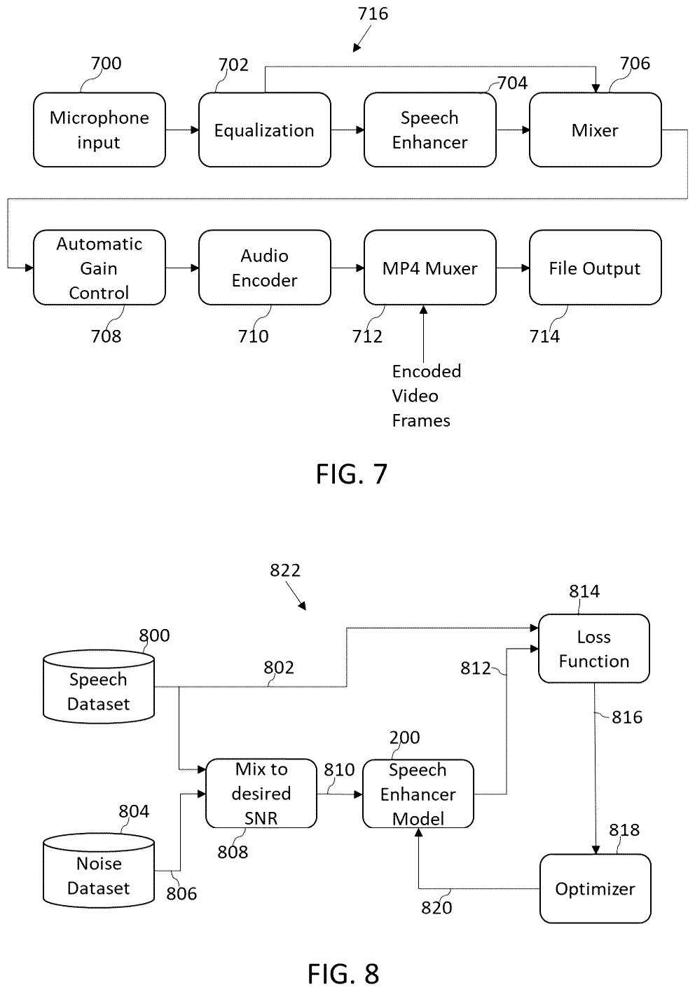

FIG. 7 shows an example use case for a model;

FIG. 8 shows an example training process for a model;

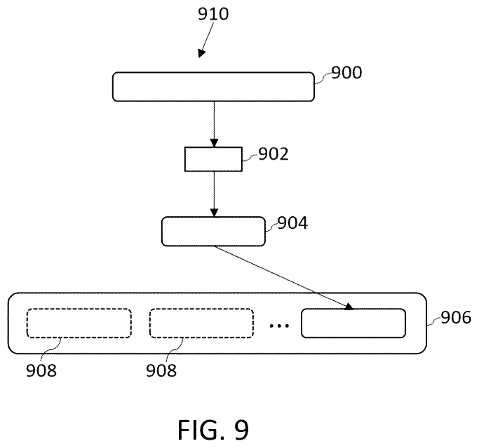

FIG. 9 shows input sequence formation;

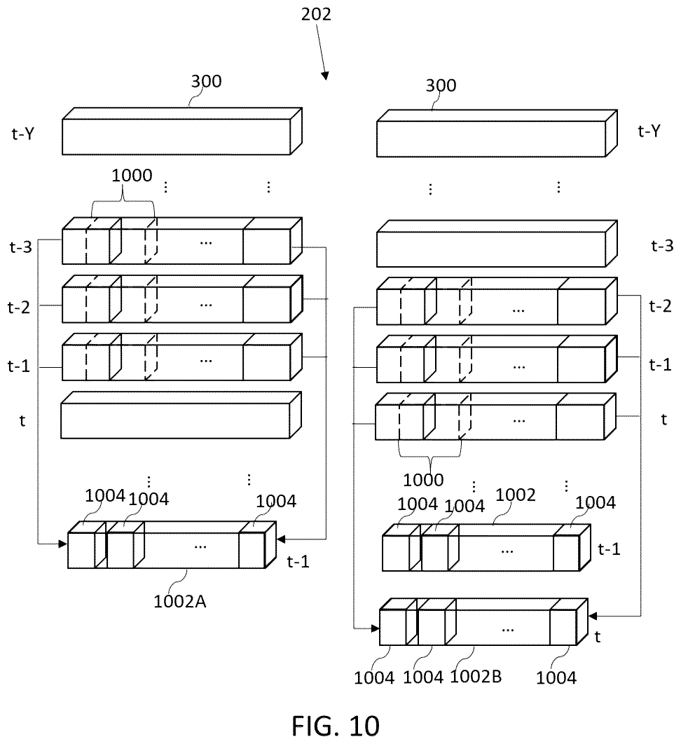

FIG. 10 shows an example encoder part;

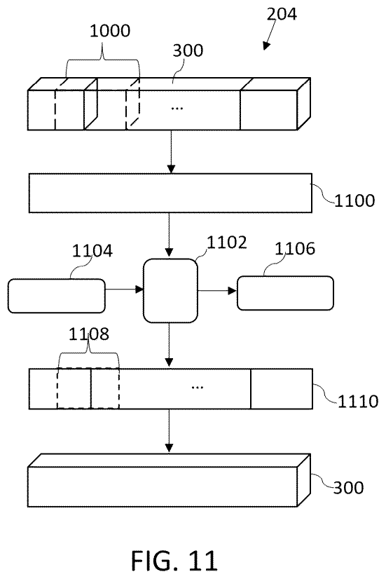

FIG. 11 shows an example bottleneck;

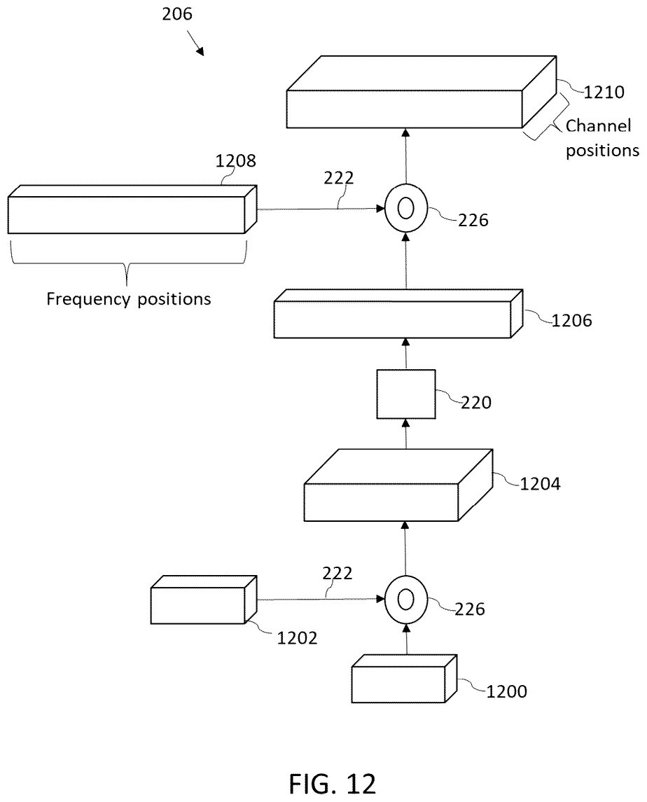

FIG. 12 shows an example decoder part;

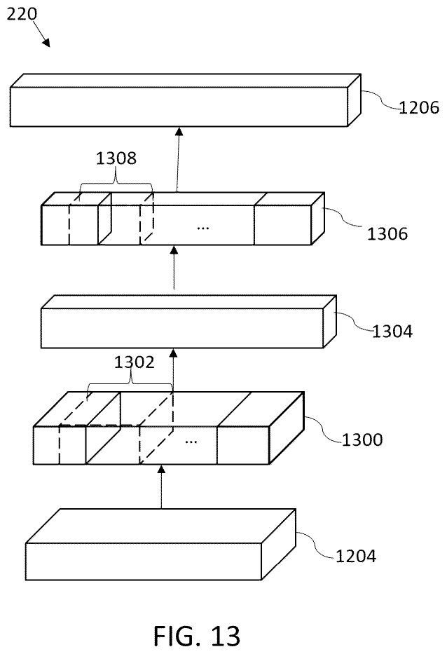

FIG. 13 shows an example decoding layer;

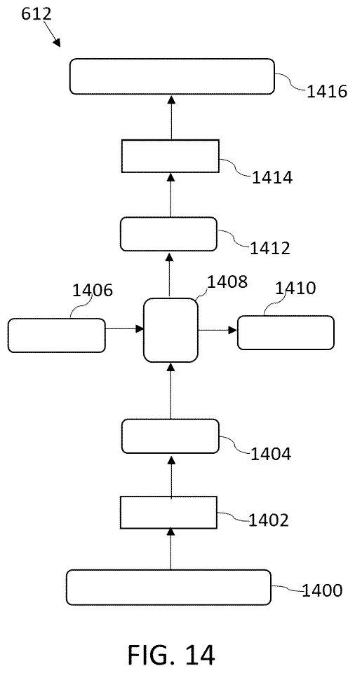

FIG. 14 shows an example post processing part;

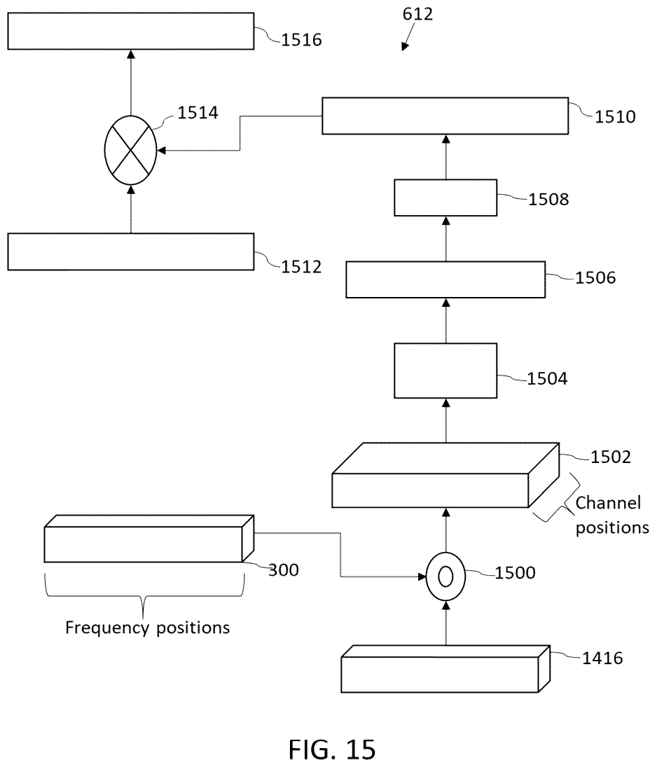

FIG. 15 shows an example post processing part;

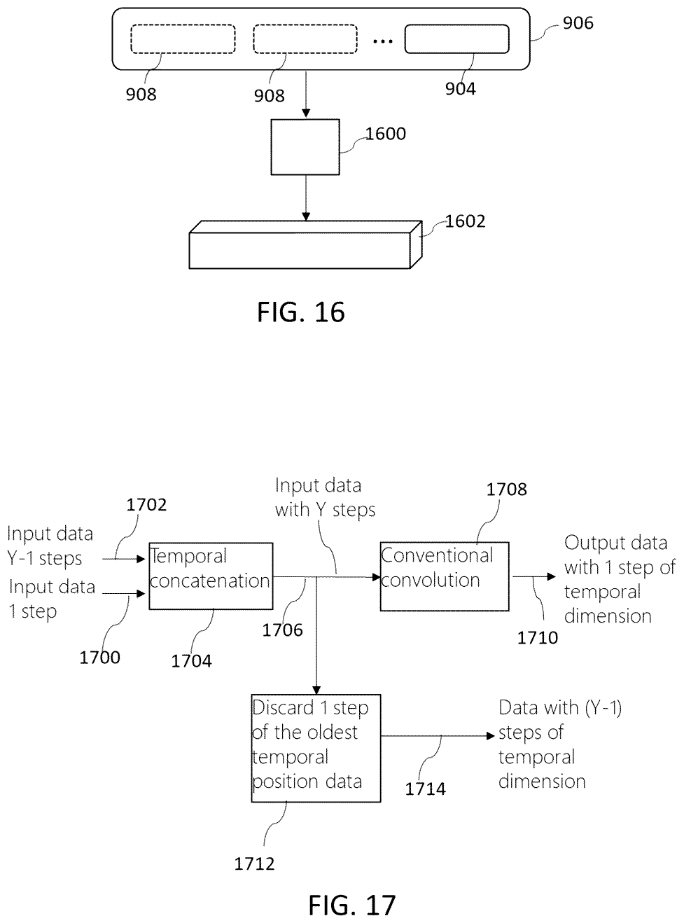

FIG. 16 shows an example input sequence processing;

FIG. 17 shows an example temporal storing convolution operator; and

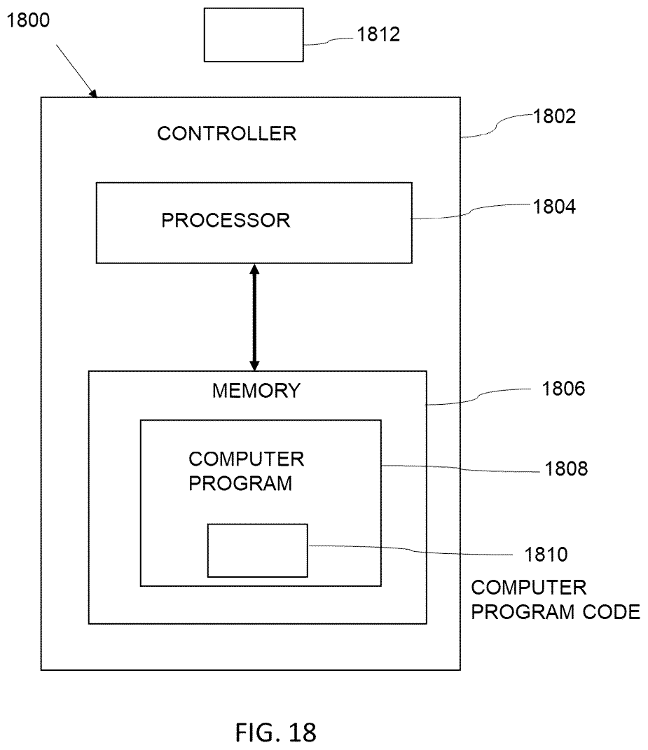

FIG. 18 shows an example apparatus.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### Definitions

A model can refer to a set of processing instructions the coefficients of which have been trained based on data.

A model can comprise multiple defined processing steps, and can be similar to the processing instructions related to conventional program code. The difference between conventional program code and the model is that the instructions of the conventional program code are defined more explicitly at the programming time. The instructions of the model are defined by combining a set of predefined processing blocks (such as convolutions, data normalizations, other operators), where the weights of the model are unknown at the model definition time. The weights of the model are optimized by providing the model with a large amount of input and reference data, and the model weights then converge so that the model learns to solve a given task. In this case the task is processing the inputs to generate output signals for speech enhancement. In examples of the disclosure, when the model is used, the model would be fixed and would correspond to a set of processing instructions.

“Signal” can refer to a single channel of a multi-channel signal, or to a multi-channel signal, or to any other type of a signal.

“Channel” can refer to one channel of an audio signal.

“Feature” can refer to one dimension of the data going through the model.

### DETAILED DESCRIPTION

FIG. 1 shows an example system 100 that could be used to implement examples of the disclosure. The example system 100 provides a communication setting.

The system 100 shown in FIG. 1 can be used for audio communications. The audio communications can comprise voice and/or speech communications. Audio from a near-end user can be detected, processed and transmitted for rendering and playback to a far-end user. In some examples, the audio from the near-end user can be stored in an audio file for later use. Examples of the disclosure could also be used in other systems and/or variations of this system 100.

The system 100 comprises a first user device 102A and a second user device 102B. In the example shown in FIG. 1 each of the first user device 102A and the second user device 102B comprise communication devices, for example, mobile communication devices or mobile telephones. Other types of user devices 102 could be used in other examples. For instance, the user devices 102A or 102B could be a telephone, a tablet, a soundbar, a microphone array, a camera, a computing device, a teleconferencing device, a videoconferencing device, a headphone, a smart speaker, a television, a set top box, a Virtual Reality (VR)/Augmented Reality (AR)/Extended Reality (XR) device, a vehicle implemented communication device, an vehicle implemented infotainment device, or any other suitable type of communications device, or any combination thereof.

The user devices 102A, 102B comprise one or more microphones 104A, 104B and one or more loudspeakers 106A, 106B. In the example of FIG. 1 there are M microphones 104 and N loudspeakers in the user device 102A, 102B. The number of microphones 104 and/or loudspeakers 106 does not need to be the same in the respective user devices 102A, 102B. The respective user devices 102A, 102B can have different numbers of microphones 104 and loudspeakers 106. The one or more microphones 104A, 104B are configured to detect acoustic signals and convert acoustic signals into output electrical audio signals. The output signals from the microphones 104A, 104B can provide respective microphone signals. The one or more loudspeakers 106A, 106B are configured to convert an input electrical signals to respective output acoustic signals that a user can hear.

The user devices 102A, 102B can also be coupled to one or more peripheral playback devices 108A, 108B. The playback devices 108A, 108B could be headphones, loudspeaker set ups or any other suitable type of playback devices 108A, 108B, for example, a camera, a computing device, a teleconferencing device, a video conferencing device, a headphone, a smart speaker, a television, a set top box, a Virtual Reality (VR)/Augmented Reality (AR)/Extended Reality (XR) device, a vehicle implemented communication device, an vehicle implemented infotainment device, or any other suitable type of communications device, or any combination thereof. The playback devices 108A, 108B can be configured to enable spatial audio, or any other suitable type of audio to be played back for a user to hear. In examples where the user devices 102A, 102B are coupled to the playback devices 108A, 108B the microphone signals, or any other audio signals, can be processed and provided to the playback devices 108A, 108B instead of to the loudspeaker 106A, 106B of the user device 102A, 102B. In some other implementations, the playback device 108A or 108B comprises the same communication and computational means as the devices 102A or 102B. In some other or additional implementations the user device 102A and the playback device 108A can share.

The user devices 102A, 102B also comprise audio processing means 110A, 110B. The processing means 110A, 110B can comprise any means suitable for processing microphone signals from the microphones 104A, 104B and/or audio signals that are provided to the loudspeakers 106A, 106B and/or playback devices 108A, 108B. The processing means 110A, 110B could comprise one or more apparatus 1800 as shown in FIG. 18 and described below and/or any other suitable means.

The processing means 110A, 110B can be configured to perform any suitable processing on the microphone signals and/or any other suitable signals. For example, the processing means 110A, 110B can be configured to perform speech enhancement and/or any other suitable process on the microphone signals and/or any other suitable signals. The processing means 110A, 110B can be configured to perform, for example, spatial rendering and/or dynamic range compression on input electrical signals for the loudspeakers 106A, 106B and/or playback devices 108A, 108B. The processing means 110A, 110B can be configured to perform other processes such as active gain control, source tracking, head tracking, audio focusing, or any other suitable process or any combination thereof.

The processing means 110A, 110B can be configured to use computer programs such as one or more machine learning models to process the microphone signals. The machine learning models can be configured as described or in any other suitable manner.

The processed audio signals can be transmitted between the user devices 102A, 102B using any suitable wired or wireless communication networks. In some examples the communication networks can comprise telecommunication networks, such as 4G, 5G, 6G or any further generation of 3GPP standard, wireless short range communication networks, such as WLAN (wireless local area network), UWB (ultra-wide band), Bluetooth® or other suitable types of networks, or any combination thereof. The communication networks can comprise one or more codecs 112A, 112B which can be configured to encode and decode the audio signals as appropriate. In some examples the codecs 112A, 112B could be IVAS (Immersive Voice Audio Systems) codecs or any other suitable types of codec.

The processing means 110A, 110B can be configured to perform speech enhancement on signals within the system 100. The purpose of speech enhancement is to improve the intelligibility of speech, voices or other desired sounds within the audio. Examples of these other desired sounds include other human utterances such as singing or laughing. For example, speech enhancement can be used to enhance the perception of a speech signal.

Speech enhancement can comprise the task of processing an audio signal to remove interferences from speech. For example, speech enhancement can comprise removing all kinds of noise (referred to as denoising), removing the reverberation captured with the speech in a speech recording (referred to as de-reverberation), expanding the bandwidth of a speech signal (referred to as speech bandwidth expansion), (residual) echo suppression, or any combination of these. For the purposes of speech enhancement the speech can comprise any vocal sounds made by a person such as talking, singing, laughing or other similar noises. In a similar manner, also the voice and sound signals can be enhanced.

Speech enhancement can be performed in different ways depending on the temporal availability of the speech signal. The speech enhancement can be performed in a causal way where the noisy speech signal is processed as it is received. That is, the noisy speech signal is processed in a frame-by-frame basis. Alternatively, if the whole noisy speech signal is available for speech enhancement the speech enhancement can be performed in a non-causal way. When the speech enhancement is performed in a causal way the speech enhancement method only has access to the history of the speech signal that is to be enhanced. When the speech enhancement is performed in a non-causal way the speech enhancement method has access to the whole of the speech signal that is to be enhanced. When a system 100 is being used for continuous and real-time communication, causal speech enhancement methods would be used. Any audio signal, such as a voice signal, can be processed the same way.

Models such as deep neural networks (DNNs) can be used for speech enhancement. For example a DNN can be arranged to take a noisy speech signal as an input and predict a mask (for example a filter or a set of real or complex valued gains in time and frequency) as output. The mask can be applied to the input signal. In some examples the output of the DNN could be the enhanced speech signal.

A typical DNN-based method for speech enhancement can have millions of parameters, for example 4-6 million, and can use computations based on logarithms, which are cumbersome in terms of computations.

In systems such as the system 100 shown in FIG. 1 the speech enhancement can be performed by any suitable device or entity within the system 100. The speech enhancement could be performed by a device that has abundant resources such as a server in a cloud, by a device that has reduced resources such as a mobile device, by a device that has scarce resources such as a wearable device depending on the characteristics of the DNN algorithm.

Examples of the disclosure relate to a model that can be used for implementing speech enhancements in a system 100 such as the system of FIG. 1. The model is computationally efficient so it could be implemented by any suitable device within such systems 100.

In examples of the disclosure the model for speech enhancement comprises a DNN architecture called a U-Net or UNet.

FIG. 2 schematically shows a causal UNet architecture that can be used as a model 200 for speech enhancement in examples of the disclosure.

The UNet architecture comprises an encoder part 202, a bottleneck 204, and a decoder part 206.

The UNet receives input data 208. The input data 208 is based on an audio frame of a given length. The audio frame can be represented in a frequency domain (for example, the Short-Time Fourier Transform (STFT) domain) or derivatives thereof, and/or in a temporal domain. This can comprise multiple data elements in the frequency dimension and/or the temporal dimension. The input data 208 can also have a feature dimension with one or more data elements along that dimension. When the model 200 is used for speech enhancement the input data 208 can be based on a noisy speech signal. Other types of input data 208 can be used for other types of audio enhancement. In some examples there are more than one inputs to the model 200. For instance, information from past frames can be circulated from outside of the model 200 (based on prior calls of the model 200)

The input data 208 is provided to the encoder part 202. The encoder part 202 is configured to extract features from the input data 208. The encoder part 202 comprises a sequence of encoding layers 210. The encoder part 202 can comprise X encoding layers 210. The encoding layers 210 can comprise convolutional operations such as convolutional neural networks (CNN). The encoding layers 210 can reduce the dimensions of the input data 208 along at least some axes.

The encoder part 202 provides output data 212. The output data 212 of the encoder part 202 has a smaller number of data elements in the temporal axis than the input data 208.

In this example the output data 212 of the encoder part 202 is provided to the bottleneck 204. The bottleneck 204 can be arranged to capture important features from the output data 212 of the encoder part 202.

The bottleneck 204 provides output data 214. The output data 214 of the bottleneck 204 can have the same or a smaller number of data elements in the temporal axis than the output data 212 of the encoder part 202.

The output data 214 of the bottleneck 204 can be provided to a concatenation block 216. The concatenation block 216 can be configured to concatenate the output data 214 of the bottleneck 204 with the output data 212 of the encoder part 202 to provide concatenated data 218. The concatenation can be performed along the feature dimension. The concatenation can reintroduce features from the output data 212 of the encoder part 202 into the output data 214 of the bottleneck 204.

The concatenated data 218 is provided as an input to the decoder part 206. The decoder part 206 is configured to reconstruct output data. The decoder part 206 comprises a sequence of decoding layers 220. The decoder part 206 can comprise X decoding layers 220 where X is also the number of encoding layers 210 in the encoder part 202. The decoding layers 220 can comprise transposed convolutional operations such as transposed convolution neural networks. The decoding layers 220 can comprise operations to combine data from a skip connection signal 222 with input data and operations to increase the dimensions of data that is input to the decoder part 206. In the example of FIG. 2, the decoding layers 220 are arranged to increase the dimensions of the concatenated data 218 in the frequency axis.

The decoder part 206 also comprises skip connections 222. The skip connections 222 are configured to relay skip connection signals 222 from respective encoding layers 210 to corresponding decoding layers 220. The skip connections 222 can reintroduce features from the encoder part 202 back into corresponding layers of the decoder part 206. The feature-wise concatenation 226 or any other suitable means can be used for the data relayed by the skip connections 222.

The decoder part 206 provides output data 224. The output data 224 of the decoder part 206 has the same number of data elements in the frequency dimension as the input data 208 that is originally provided to the encoder part 202. The output data 224 can be used to provide an output signal for speech enhancement. For example, the output data 224 can be used to provide an output mask for filtering a noisy speech signal or the output data 224 could comprise an enhanced speech signal or enhanced speech amplitudes.

FIG. 3 shows a kernel 302 processing a frame of data 300 in an encoder layer 210 of the model 200 shown in FIG. 2. The frame of data 300 is for a single temporal position. Future and previous temporal positions would have their own corresponding frames and would be processed by the same kernel 302.

As shown in FIG. 3 the kernel 302 is applied to the frame of data 300 to provide an output frame 304. The respective positions in the output frame 304 comprise the result 306 of the application of the kernel 302 to corresponding positions of the frame of data 300.

In the examples of FIGS. 2 and 3 encoding layers 210 process the input frame 300 using a kernel 302 that only operates in a frequency dimension. This does not enable temporal patterns that span multiple frames to be discovered. Examples of the disclosure as described below address this issue by providing a computationally efficient model 200 for audio enhancement that enables temporal patterns to be accounted for.

FIG. 4 schematically shows another example of the model 200 for speech enhancement. The model 200 can be provided within any suitable apparatus or device.

The model 200 comprises the encoder part 202 and the decoder part 206.

The encoder part 202 comprises a sequence of encoding layers. An encoding layer comprises one or more operations that are performed on an input to provide an encoded output. In some examples the encoding layers of the encoder part 206 comprise convolutional operations. In some examples at least one of the encoding layers uses a kernel comprising multiple temporal components to process data elements corresponding to more than one temporal position. In some examples at least one of the encoding layers uses a kernel that uses dilation in the temporal dimension. The dilation in the temporal dimension allows the kernel to process time steps that are not next to each other and this enables historical information from the received input data 400 to be retained.

The encoder part 202 is caused to receive the input data 400 where the input data 400 is based on a current frame of a noisy speech signal and one or more past frames of the noisy speech signal. The input data comprises data elements corresponding to multiple frequency positions and multiple temporal positions. The sequence of encoding layers is caused to process the input data 400 so that output data of the encoder part 202 comprises a reduced number of the frequency positions and a single temporal position.

The decoder part 206 comprises a sequence of decoding layers. A decoding layer comprises one or more operations that are performed on an input 402 to provide a decoded output 406. The decoding layers within the sequence are caused to receive data from a prior decoding layer. The first decoding layer within the sequence would receive an output from outside of the decoder part 206 and so would not receive data from a prior decoding layer. The subsequent layers within the sequence could all receive data from a prior decoding layer.

At least one of the decoding layers is configured to receive data from a prior decoding layer and an encoding layer.

The sequence of decoding layers is caused to process the received data 402 so that the output data 404 of the decoder part 206 comprises multiple frequency positions and a single temporal position. In some examples the sequence of decoding layers is caused to process the received data so that the output data 404 of the decoder part 206 comprises the same number of frequency positions as the input data for the encoder part and a single temporal position

The output data 404 of the decoder part 206 is for post processing to provide an output signal for speech enhancement. The output 404 of the decoder part 206 is further processed using any suitable means or operations.

The model 200 can comprise components that are not shown in FIG. 3. For example the model 200 can comprise one or more skip connections 222. The skip connections 222 can be caused to relay skip connection signals from respective encoding layers to corresponding decoding layers. The skip connections 222 enable at least one of the decoding layers to receive data from an encoding layer. The skip connection signals can comprise a single temporal position. The encoding layers can process multiple temporal positions, but from these multiple frames only a single position in the temporal dimension signal is used as a skip connection signal to the corresponding decoding layers of the decoder part 206.

The decoding layers of the decoder part 206 can comprise operations to combine data from a skip connection 222 signal with received data from a prior decoding layer and operations to increase the frequency positions of the combined data. In some examples the decoding layers of the decoder part 206 can comprise operations to combine data from the skip connection signal received via the skip connection 222 with received data from a prior decoding layer and a linear interpolation process and operations configured to increase the frequency positions of the combined data.

In some examples the model 200 could comprise an input layer. The input layer can be caused to generate input data 400 for the encoder part 202. The input data 400 can be generated based on the current frame. The input layer can also be configured to store input data based on past frames.

In some examples the model 200 could comprise a bottleneck. The bottleneck can comprise one or more layers caused to process the output data 402 of the encoder part 202 into bottleneck output data that comprises a single temporal position. In examples where the model 200 comprises the bottleneck the decoder part 206 is configured to receive and process the bottleneck output data. The bottleneck can comprise any suitable operations. In some examples the bottleneck can comprise a recurrent neural network (RNN) layer. In some examples the bottleneck can comprise a recurrent auto-encoder. The recurrent auto encoder can comprise a linear layer followed by a recurrent neural network and then another linear layer. The bottleneck can comprise a single recurrent neural network.

The post processing of the output data 404 of the decoder part 206 can be performed by a post processing part. The post processing part can be part of the model or can be outside of the model. The post processing part can comprise one or more layers caused to process the output data of the decoder part 206 to provide an output signal for the speech enhancement. In some examples the post processing part comprises a recurrent layer that is caused to process the output data 404 of the decoder part 206 to provide an output mask for the speech enhancement or an enhanced speech signal.

The speech enhancement that is performed by the model can comprise any process that improves the intelligibility or quality of speech in a noisy speech signal. In some examples the speech enhancement can comprise any one or more of denoising, echo suppression, de-reverberation, speech bandwidth expansion, packet loss concealment improvement, wind noise removal, recovery of missing speech signal, (residual) echo suppression, jet engine noise removal, or non-linear distortion removal, or any combination thereof.

FIG. 5 shows an example method. The method could be implemented using the model 200 as shown in FIG. 4 or any other suitable type of model.

At block 500 the method comprises receiving input data 400. The input data 400 is based on a current frame of a noisy speech signal and one or more past frames of a noisy speech signal. The input data 400 comprises data elements corresponding to multiple frequency positions and multiple temporal positions.

At block 502 the method comprises encoding the input data 400 using a sequence of encoding layers to provide output data 402 of the encoding. The output data 402 of the encoding comprises a reduced number of frequency positions and a single temporal position.

At block 504 the method comprises decoding the output data 402 of the encoding using a sequence of decoding layers. The decoding layers are configured to receive data from a prior decoding layer. At least one of the decoding layers is configured to receive data from a prior decoding layer and an encoding layer and to provide output data 404 of the decoding. The output data 404 of the decoder part comprises multiple frequency positions and a single temporal position.

At block 506 the method comprises processing the output data of the decoding to provide an output signal for speech enhancement.

Examples of the disclosure provide an efficient model 200 for speech enhancement. The model 200 is efficient because it can use a low number of parameters or positions and so has a low computational complexity, and/or a low memory footprint.

The encoder part 202 of the model 200 can store recent history data of the input signal. Therefore the recent history data does not need to be recalculated by encoding layers within the encoding part. The storing may happen by the encoding layers, or the storing may be performed by the program code calling the model 200. This is effective for processing input data in a frame-by frame basis. The computation complexity of the encoder part 202 can also be further reduced through the selection of appropriate operations. For example, the encoding layers could comprise a single gated recurrent unit (GRU).

In examples of the disclosure the model 200 can learn short to mid length temporal patterns even though the input data comprises a single vector. The learning of the temporal patterns can be achieved by using dilation in the temporal dimension in the kernel and/or by using look-back vectors. Also, history values are reused from calculations of the encoding layers from the processing of previous input vectors. This also reduces the number of computations that are needed.

Also the model 200 can be arranged to learn and exploit the mid-length and long temporal patterns on the output of the encoder part 202 with computationally light structures. For example the output of the encoder part 202 can be processed by a bottleneck 204 or other structure that can have low complexity. For example, the structure could be just one recurrent neural network (RNN).

The model 200 can also be arranged to learn and exploit mid length and long temporal patterns at the decoder, while providing a signal for speech enhancement. For example, the output of the model 200 can be used for post processing that learns temporal patterns in the output of the model and provides a suitable signal for speech enhancement. The signal for speech enhancement can comprise an enhanced signal or an output mask for speech enhancement or any other suitable type of signal. The post processing can reuse historical data in a causal processing manner. The post processing can comprise an RNN or any other suitable operations.

The model 200 can operate in real time or substantially real time because the inputs comprise a single vector and the model 200 has low complexity. Also the model 200 can be used for causal operation because the learning of the temporal patterns is based on historical values and not future values.

FIG. 6 shows another example of the model 200 that can be used in some examples of the disclosure. The model 200 can be implemented by devices with limited resources such as the user devices 102A, 102B in the example system 100 of FIG. 1.

In this example an input 600 comprises a single frame or timestep of an audio signal such as a noisy speech signal. The frame can be obtained by short-time Fourier Transform (STFT) or any other suitable process.

A transform block 602 is configured to transform the input 600 to smaller dimensions. The transform performed by the transform block 602 can be an affine transform. The transforms of a given number of previous frames can also be stored. For example, the transforms of the last x frames can be stored.

Input data 604 comprising the transform of the current frame of the noisy speech signal and the transform of one or more of the previous frames is provided as an input to the encoder part 202.

The encoder part 202 comprises a sequence of encoding layers. The encoding layers can comprise convolutional operations. The convolutional operations can comprise temporally storing convolutional operations. The temporally storing convolutional operations take input data that has size one in the temporal axis, even if the kernel size (with any potential dilations) at that axis would be larger than one.

The encoding layers of the encoder part 202 are arranged so that the output 606 of the encoder part 202 has a single temporal position. The encoding layers also act to reduce the number of frequency positions of the input data 604. This reduction can be less than the reduction in the number of temporal positions. The output 606 of the encoder part 202 therefore has a number of frequency positions which is smaller than the number of frequency positions of the input data 604 but which can be greater than one.

The output 606 of the encoder part 202 is provided to the bottleneck 204. The bottleneck 204 comprises one or more layers arranged to process the output 606 of the encoder part into the output 608 of the bottleneck. The output 608 of the bottleneck 204 comprises a single temporal position.

The layers of the bottleneck 204 can comprise any suitable operations. The operations can be arranged to process the single temporal position of the output 606 of the encoder part 202. In some examples the bottleneck 204 can comprise a single GRU.

The model 200 is arranged so that the output 608 of the bottleneck 204 is provided to the decoder part 206. The decoder part 206 comprises a sequence of layers. The first decoding layer is configured to receive the output 608 of the bottleneck as an input.

Subsequent decoding layers are configured to receive data from a prior decoding layer as an input.

One or more of the decoding layers are also arranged to receive data from an encoding layer as an input. One or more skip connections 222 can be used to relay skip connection signals from respective encoding layers to corresponding decoding layers. The one or more skip connections 222 enable one or more decoding layers to receive data from an encoding layer.

The skip connections 222 are between corresponding encoding layers and corresponding decoding layers. The skip connections 222 can be configured to take the last temporal step in the output of the encoding layer and concatenate it in on the feature dimension to the input for the corresponding decoding layer. The skip connections 222 can be configured to apply an operation to combine two or more temporal steps in the output of the encoding layer to one temporal step and concatenate the result on the feature dimension to the input for the corresponding decoding layer.

The decoding layers can comprise transposed convolutional operations. The transposed convolutional operations are arranged to increase the number of frequency positions of the output 608 of the bottleneck 204 so that the output 610 of the decoder part 206 comprises a single temporal position but multiple frequency positions. The number of frequency positions of the output 610 of the decoder part 206 can match the number of frequency positions of the input data 604.

The output 610 of the decoder part 206 is provided for post processing 612. The post processing 612 can comprise any suitable processing that enables the output 610 of the decoder part 206 to be used to provide an output signal 614 for audio enhancement. The output signal 614 for audio enhancement could comprise an output mask for audio enhancement or an enhanced audio signal or any other suitable output signal. In examples where the model 200 is used for speech enhancement the post processing 602 can be arranged to predict the magnitude spectrum of clean speech contained in a noisy speech input. Other types of output 614 could be provided in other examples.

The post processing 612 can comprise a recurrent auto encoder. The post processing 602 can comprise a GRU. The post processing 602 can be arranged to process the single temporal position of the output 610 from the decoder part 206.

FIG. 7 shows an example use case 716 for a model 200 for speech enhancement according to examples of the disclosure. In this example the model 200 for speech enhancement is used for speech enhancement in a video recorder application as part of the audio capture processing chain. The audio capture and processing can be performed by a user device 102 or by any other suitable device in a communication system 100. Other types of speech enhancement could be used in other examples.

The audio processing chain starts with a microphone input 700. The microphone input 700 comprises microphone signals. The microphone signals 700 can be captured by one or more microphones 104 of the user device 102 or by any other suitable microphones.

The microphone signals within the microphone input 700 comprise a varying amount of noise. For a use case of recoding video using the user device 102 the noise could comprise traffic noise, air conditioning noise, babble noise (noise caused by the speech of other people in a crowded space), or any other suitable type of noise.

At block 702 the microphone signals are equalized and the equalized signals are provided to a speech enhancement block 704. The speech enhancement block 704 can use the model 200 as described to perform speech enhancement on the equalized microphone signals. Other types of speech enhancement could be used in other examples.

The output of the speech enhancement block 704 comprises a denoised speech signal. At block 706 the denoised speech signal is mixed with the noisy speech signal. The mixing is configured to achieve a result that is not completely free of noise but is pleasant for a listener. For example, the mixing can preserve a controlled amount of background ambience. In some examples the mixing can help in masking processing artifacts which could be caused by the speech enhancement processing.

The output of the mixer is provided to a control block 708. The gain control can be automatic. The gain control can be configured to keep the signal level audible and prevent the signal from distorting if the input level gets too high.

The output of the gain control is provided to an audio encoder block 710. The audio encoder can be a lossy compression for storing the audio signal. The output of the audio encoder block 710 is a compressed audio signal.

The compressed audio signal is provided to a multiplexer block 712. The multiplexing can combine the compressed audio signal with encoded video frames. The encoded video frames can be obtained from a camera of the user device 102 or from any other suitable source. The multiplexer can comprise an MP4 multiplexer or any other suitable type of multiplexer.

The multiplexer 712 provides a file output 714. The file output can be stored in a memory of the user device 102 and/or can be sent over a communication network to one or more other user devices 102.

FIG. 8 shows an example training process 822 for the model 200 according to examples of the disclosure. In this case the model 200 is trained for speech enhancement.

The training process uses two separate datasets. In this example the training process uses a speech dataset 800 and a noise dataset 804. The speech dataset 800 comprises clean speech. The noise dataset 804 comprises representative noise signals.

In the training process, at block 808, input examples are constructed by mixing clean reference speech 802 from the speech dataset 800 and noise signals 806 from the noise dataset 804. The noise signals 806 can be randomly selected segments of noise from the noise dataset 804 that have a length that matches the length of the clean reference speech 802. At block 808 the clean reference speech 802 and the noise signal 806 are mixed to a desired signal to noise ratio (SNR) to create noisy speech signals 810.

A batch of noisy speech signals 810 is provided as an input to the model 200 for speech enhancement so as to enable training of the model 200.

During training the noisy speech signals 810 are provided as an input to the model 200. The model 200 uses current weights to predict a denoised output 812. The denoised output 812 can comprise predicted speech.

The denoised output 812 and the original clean reference speech 802 that was used to construct the noisy speech 810 are provided to a loss function 814. The loss function 814 can compare the difference between the denoised output 812 and the original clean reference speech 802 and provides a loss value 816 as an output.

The loss value 816 is provided to an optimizer 818. The optimizer 818 receives the loss value and performs a backward pass on the model 200 and adjusts the weights of the model 200 so as to reduce the loss. The optimizer 818 provides updated weights 820 for the model 200. The updated weights 820 are used in the next iteration of the training. The iterations of the training are repeated until criteria for prediction quality are met or until further iterations do provide any lower losses.

FIG. 9 schematically shows a process 910 that can be used for formation of an input sequence 906. The input sequence 906 can comprise the input data that is provided as an input to the model 200 or to the encoder part 202 of the model 200 in implementations of the disclosure. The input sequence 906 can be based on a current frame of a noisy speech signal and/or any other suitable type of signal.

To form the input sequence 906 a short-time Fourier transform (STFT) of the current frame 900 is obtained as an input frame. In some embodiments the STFT data is in form of STFT amplitudes or energies only. The STFT frame 900 is provided as an input to a linear layer 902. The linear layer 902 maps the STFT frame 900 to a lower dimensionality and provides a mapped STFT frame 904 as an output.

The input sequence 906 is then constructed from the mapped STFT frame 904 and from past mapped frames 908. The past mapped frames 908 can be the most recent historical frames or could be any suitable past frames. In the first forward pass of the model 200 the past mapped frames 908 would be vectors of zeros. In subsequent forward passes of the model 200 the current mapped frame 904 can be used as one of the past mapped frames 908.

FIG. 10 schematically shows an example of the encoder part 202 that can be used in some examples of the disclosure. The encoder part 202 can be arranged to learn temporal patterns from the input data. The temporal patterns can be learned through by using a two-dimensional kernel 1000 in the encoder part 202 instead of the kernel 302 with a single-dimension as shown in FIG. 3.

In FIG. 10 an input sequence comprising a current frame and Y frames of past data is shown. Each of the blocks represents a single frame 300 of data within the input sequence 906.

The two-dimensional kernel 1000 is applied to multiple frames of data 300 to provide an output frame 1002A, B. The respective positions in the output frame 1002 comprise a result 1004 of the application of the two-dimensional kernel 1000 to corresponding positions of the current frame of data and past frames of data. In this example the two-dimensional kernel 1000 has three temporal components 1004. The two-dimensional kernel 1000 could have any suitable number of temporal components 1004.

In the example of FIG. 10 the output frame 1002A for the previous frame t−1 is shown on the left hand side and the output frame 1002B for the current frame t is shown on the right hand side. The output frame 1002A for the previous frame t−1 comprises the results 1004 of the application of the two-dimensional kernel 1000 to multiple past frames. The output frame 1002B for the current frame comprises the results 1004 of the application of the two-dimensional kernel 1000 to the current frame and also multiple past frames.

As shown in FIG. 10, the two-dimensional kernel 1000 can process multiple frames of data simultaneously. The two-dimensional kernel 1000 can process a frame of data from a current input and also one or more frames of data from past inputs. This therefore enables the two-dimensional kernel 1000 to identify temporal patterns that emerge in the input sequence 906.

The two-dimensional kernel 1000 is shown in FIG. 10 without any dilations so that the two-dimensional kernel 1000 operates on consecutive time frames. In other examples the two-dimensional kernel 1000 could use dilation so that the two-dimensional kernel 1000 operates on time frames that are not consecutive but that are separated by one or more frames. The number of frames that separate the frames that the two-dimensional kernel 1000 operates on is determined by the dilation factor of the two-dimensional kernel 1000.

The encoder part 202 is also arranged so that the temporal information is aggregated in successive encoding layers 210. The aggregation arises because every output from an encoder layer 210 is based upon cascaded processes from two-dimensional kernels 1000. This aggregation can be enhanced if the two-dimensional kernel 1000 also uses dilation.

The output of the encoder part 202 therefore comprises temporal patterns from the whole input sequence 906.

FIG. 11 schematically shows an example bottleneck 204 that could be used in some examples of the disclosure. The bottleneck 204 is arranged to process the output data of the encoder part into bottleneck output data that comprises a single temporal position. The bottleneck 204 can comprise any suitable operations. In this example the bottleneck 204 comprises a first CNN (convolutional neural network), an RNN (recurrent neural network) and a second CNN.

The bottleneck 204 is configured to receive the output of the encoder part 202 as an input. The input to the bottleneck 204 comprises a single frame of data 300 with multiple features. The input comprises a tensor having a feature map and time and frequency information. The first CNN (not shown in FIG. 11) processes the single frame of data 300 with a multi-feature kernel 1000. The provides an output of a single frame of data 1100 with a single feature. The single frame of data 1100 is reshaped to a vector using the feature dimension as the dimension of the vector.

The vector is provided to an RNN 1102. The RNN correlates the vector for the current time step to the vector used as the input for one or more of the previous time steps 1104.

The output of the RNN 1102 is provided as an input to the second CNN (not shown in FIG. 11) of the bottleneck 204. The output of the RNN 1102 is also provided as an input 1106 for the RNN of the next time step.

The second CNN is a transposed CNN. The second CNN is configured to upscale the frequency dimension of the input to match the frequency dimension of the first CNN. The output of the second CNN 1110 comprises a single time-step 1108. The output of the second CNN is given as an input to the decoder part 206 of the model 200.

Other types of operations can be used for the bottleneck 204 in other examples. For instance a recurrent auto-encoder could be used instead of an RNN. An example of a recurrent auto-encoder is shown in FIG. 13.

FIG. 12 shows an example decoder part 206 that can be used in some examples of the disclosure. The decoder part 206 comprises a sequence of decoding layers 220. The sequence of decoding layers 220 are arranged to process received data to increase the number of frequency positions.

In the example of FIG. 12 the number of frequency positions (frequency dimension) is qualitatively indicated by the horizontal length of the blocks and the number of feature positions (feature dimension) is qualitatively indicated by the depth of the blocks.

The decoding layer 220 shown in FIG. 12 receives an input comprising data 1200 from a prior decoding layer (not shown in FIG. 12) and data 1202 from an encoding layer (not shown in FIG. 12). The data 1202 is received from a corresponding encoding layer 210 in the encoder part so that the data 1200 from the prior decoding layer 220 and the data 1202 from the encoding layer 210 have the same number of frequency positions.

The first decoding layer 220 in a sequence would not receive an input comprising data from a prior decoding layer 220 but would instead receive an input from a bottle neck 204 or other suitable part.

The data 1202 from the encoding layer can be received via a skip connection 222. The data 1202 from the encoding layer can comprise a single temporal position but can comprise multiple frequency positions. The skip connection 222 enables feature wise concatenation 226 of the data 1200 from the prior decoding layer and the data 1202 from the encoding layer. The output 1204 of the concatenation 226 is provided as an input to the decoding layer 220. The output 1204 of the concatenation 226 increases the number of feature positions compared to the data 1200 from the prior decoding layer and the data 1202 from the encoding layer.

The decoding layer 220 comprises operations that may increase the number of frequency positions so that the output 1206 of the decoding layer 220 has more frequency positions than the data 1200 that is received from the prior layer.

The output 1206 from the decoding layer is concatenated with data 1208 from another encoding layer 210. The data 1208 from another encoding layer 210 is received via another skip connection 222. The skip connection 222 enables feature wise concatenation 226 of the output 1206 of the decoding layer 220 and the data 1208 from another encoding layer 210. The output 1210 of the concatenation 226 is provided as an input to the next decoding layer 220.

FIG. 13 shows an example decoding layer 220 that can be used in the decoder part 206. In this example the decoding layer 220 comprises two CNNs. Other operations and arrangements of operations can be used in other examples.

The output 1204 of the concatenation is provided as an input to the decoding layer 220. This input comprises data from the prior decoding layer and also data from a corresponding encoding layer. The input comprises a single frame of data.

The input is provided to a first CNN 1300 for processing along a feature dimension. A first CNN kernel 1302 is used by the first CNN 1300. The output 1304 of the first CNN 1300 has a decreased feature dimension compared to the output 1204 of the concatenation. The output 1304 of the first CNN 1300 also comprises a single frame of data.

The output 1304 of the first CNN 1300 is provided as an input to the second CNN 1306 for processing along a frequency dimension. A second CNN kernel 1308 is used by the second CNN 1306. The second CNN 1306 increases the number of frequency positions. The output of the second CNN 1306 is provided as the output 1206 of the decoding layer 220.

Variations to the decoding layer 220 and decoder part 206 can be used in examples of the disclosure. For instance, instead of using transposed convolutions in the decoder part 206, a linear interpolation process, followed by a CNN or a typical CNN block (CNN, normalization, activation) could be used instead.

FIG. 14 shows an example post processing part 612. The post processing part 612 can be used to process the outputs of the model 200.

In the example of FIG. 14 the post processing part 612 comprises a recurrent auto-encoder. The recurrent auto encoder comprises a first linear layer 1402 an RNN 1408 and a second linear layer 1414. Other types of operations and/or arrangements of the operations could be used in other examples.

An input 1400 to the first linear layer 1402 is provided. The input 1400 to the first linear layer 1402 can be the output from the decoder part 206 of the model 200. The input 1400 can comprise a single frame of data. The single frame of data can correspond to a single temporal position.

The first linear layer 1400 reduces the number of frequency positions and provides an output 1404. The output 1404 of the first linear layer 1402 is provided as an input to the RNN 1408. The mapping to a lower number of frequency positions keeps the number of parameters of the RNN 1408 low.

The RNN 1408 receives a recurrent input 1406 and provides a recurrent output 1410. The RNN 1408 correlates the output 1404 of the first linear layer 1402 to the previous inputs 1406. This enables long term temporal patterns of the output of the decoder part 206 to be learned.

The RNN 1408 provides an output 1412. The output 1412 is provided to the second linear layer 1414. The second linear layer 1414 increases the number of frequency positions and provides an output 1416. The second linear layer 1414 maps the number of frequency positions back to the number of frequency positions in the input 1400.

FIG. 15 shows another example post processing part 612. The post processing part 612 in FIG. 15 can provide an output prediction. The post processing part 612 can be used to process the outputs of a recurrent auto encoder as shown in FIG. 14 to provide an output signal for audio enhancement. The post processing part 612 can be configured to process the outputs of a recurrent auto encoder or any other suitable operations to provide an output mask or an enhanced audio signal or any other suitable type of output.

In the example of FIG. 15 feature-wise concatenation 1500 is performed on the output 1416 of a recurrent auto encoder as shown in FIG. 14 and the input 300 to the encoder part 202.

The output 1502 of the concatenation 1500 is provided as an input to a CNN 1504. The CNN 1504 processes the output 1502 of the concatenation 1500 and provides the output 1506 of the CNN 1504.

The output 1506 of the CNN 1504 is provided as an input to a linear layer 1508. The linear layer 1508 is arranged to map the output 1506 of the CNN 1504 to the same number of frequency positions as the original input data. In this example the output of the linear layer 1508 is a predicted denoising mask 1510.

The predicted denoising mask 1510 is applied to a noisy input signal 1512. A Hadamard product 1514 or any other suitable operation can be used to apply the predicted denoising mask 1510 to the noisy input signal 1512. This provides a denoised output 1516. Other types of speech enhancements could be used in other examples.

FIG. 16 shows an example input sequence processing that can be used in some variations of the disclosure. The example of FIG. 16 can be used in examples where the encoding layers 210 in the encoder part 206 do not use dilated convolutions.

The input sequence 906 comprises a current frame 904 and multiple past frames 908. The input sequence 906 is provided to a CNN 1600. The CNN 1600 is arranged to consume all the past frames 908 by using a kernel with a temporal dimension that is equal to the number of past frames. The CNN 1600 provides a single time frame 1602 as an output.

In examples of the disclosure the model 200 can comprise an initial affine transform, Affⁱⁿ, an encoder part, E, a bottleneck, B, and a decoder part, D. The input to model 200 comprises data of a current frame plus data from one or more past frames and the previous states of the two RNNs. For example, the input to the model 200 comprises the STFT data of the time frame t,

$${x}_{t}^{i n} ∈ {ℝ}_{\geq 0}^{1 \times {D}_{STFT}^{in}} ,$$

the previous N_{frames} frames,

$${x}_{history} ∈ {ℝ}_{\geq 0}^{{N}_{frames} \times {D}_{P}^{in}} ,$$

the hidden state of the RNN after the encoder,

$${h}_{t - 1}^{E} ∈ {[ - 1 , 1 ]}^{1 \times {D}_{RNN - E}^{h}} ,$$

and the hidden of the RNN after the decoder,

$${h}_{t - 1}^{D} ∈ {[ - 1 , 1 ]}^{1 \times {D}_{RNN - D}^{h}} ,$$

as

$$\hat{{x}_{t}} = DNN ( {x}_{t}^{i n} , {x}_{history} , {h}_{t - 1}^{E} , {h}_{t - 1}^{D} ) \qquad ( 1 )$$

where x_{history}=[x_{t-N}_{_{frames}}, . . . , xₜ₋₁],

$${x}_{t < 0} = {[ 0 ]}^{1 \times {D}_{P}^{in}} ,$$

and

$$∈ {ℝ}_{\geq 0}^{1 \times {D}_{STFT}^{in}}$$

is the predicted output denoising mask for the input timeframe

$${x}_{t}^{i n} .$$

For example,

$${x}_{t}^{i n}$$

is given as an input to Affⁱⁿ:

$${ℝ}_{\geq 0}^{1 \times {D}_{STFT}^{in}} ↦ {ℝ}_{\geq 0}^{1 \times {D}_{P}^{in}} ,$$

as

$${x}_{t}^{aff} = {Aff}^{in} ( {x}_{t}^{i n} ) . \qquad ( 2 )$$

The affine transform can be arranged to reduce the number of frequency positions in the input. This reduces the computational complexity for the encoder part E and, consequently also reduces the computation complexity in the bottleneck B and decoder part D, when processing frequency-related information. Then,

$${x}_{t}^{aff}$$

and x_{history} are concatenated, as

$${x}_{t} = [ {x}_{t - {N}_{frames}} , … , {x}_{t}^{aff} ] , \qquad ( 3 )$$

to create an input to the encoder part E, xₜ. This input xₜ encapsulates both current and historical information.

The encoder part E, comprises N_{E-CNN-block} concatenated CNN blocks (or CNNBlocks)),

$${CNNBlock}_{{n}_{E - CNN - block}}^{E} ,$$

with n_{E-CNN-block}=1, . . . , N_{E-CNN-block}. The encoder part E is tasked with
the learning of short to mid-term temporal patterns. The encoder part E is also tasked with the reduction of both the number of temporal positions and the number of frequency positions of the employed representations. Additionally, the output from respective encoding layers within the encoder part E are used as skip connection signals that are relayed to corresponding decoding layers in the decoder part D via skip connections.

The historical information that is encapsulated in the input to the encoder part E enables the learning of temporal patterns in the encoder part E. The learning of the temporal patterns is in a causal way because the historical information is about the past of the signal and not the future. Therefore, xₜ is given as an input to the encoder part E, yielding

$${h}_{t}^{E} = E ( {x}_{t} ) , as \qquad ( 4 )$$

$${h}_{t , {n}_{E - CNN - block}}^{E} = {CNNBlock}_{{n}_{E - CNN - block}}^{E} ( {h}_{t , {n}_{E - CNN - block} - 1}^{E} ) , \qquad ( 5 )$$

where

$${h}_{t , 0}^{E} = {x}_{t} , {h}_{t}^{E} = {h}_{t , {N}_{E - CNN - block}}^{E} , {h}_{t}^{E} ∈ {ℝ}^{{C}_{E}^{out} \times {T}_{E}^{out} \times {D}_{E}^{out}} , {C}_{E}^{out}$$

is the number of output feature maps from

$${CNNBlock}_{{n}_{CNN - blocks}}^{E}$$

with n_{E-CNN-block}=N_{E-CNN-block}, and

$${T}_{E}^{out}$$

is the remaining history context that will be used in the bottleneck B.

$${h}_{t}^{E}$$

contains encoded information for the current timeframe t and learned short and mid-term temporal patterns existing in xₜ.

In some examples, a

$${CNNBlock}_{{n}_{E - CNN - block}}^{E}$$

can comprise three cascaded two-dimensional CNNs,

$$CNN - {BE}_{{n}_{E - CNN - block}}^{m} ,$$

with m=[1,2,3].

$$CNN - {BE}_{{n}_{E - CNN - block}}^{m}$$

can have a kernel size of

$${KT}_{{n}_{E - CNN - block}}^{m} \times {KD}_{{n}_{E - CNN - block}}^{m} ,$$

stride of

$${ST}_{{n}_{E - CNN - block}}^{m} \times {SD}_{{n}_{E - CNN - block}}^{m} ,$$

and dilation of

$${DT}_{{n}_{E - CNN - block}}^{m} \times {DD}_{{n}_{E - CNN - b1ock}}^{m} .$$

### Furthermore,

$$CNN - {BE}_{{n}_{E - CNN - block}}^{m}$$

can be preceded by a dropout functionality with probability

$${pE}_{{n}_{E - CNN - block}}^{m} , {DpE}_{{n}_{E - CNN - block}}^{m} ,$$

and followed by a normalization process,

$${zE}_{{n}_{E - CNN - block}}^{m} ,$$

and a non-linearity

$${gE}_{{n}_{E - CNN - block}}^{m} ,$$

as

$${h}_{t , {n}_{E - CNN - block}}^{′ m , E} = {gE}_{{n}_{E - CNN - block}}^{m} ( \text{} {zE}_{{n}_{E - CNN - block}}^{m} ( CNN - {BE}_{{n}_{E - CNN - block}}^{m} ( {DpE}_{{n}_{E - CNN - block}}^{m} ( {h}_{t , {n}_{E - CNN - block}}^{′ m - 1 , E} ) ) ) ) \qquad ( 6 )$$

$$where$$

$${h}_{t , {n}_{E - CNN - block}}^{′ m , E} ∈ {ℝ}^{{C}_{m , E}^{{n}_{E - CNN - block}} {xT}_{m , E}^{{n}_{E - CNN - block}} \times {D}_{m , E}^{{n}_{-} \_ CNN - block}} ,$$

$${h}_{t , {n}_{E - CNN - block}}^{′ 0 , E} = {h}_{t , {n}_{E - CNN - block} - 1}^{E} ,$$

$$and {h}_{t , {n}_{E - CNN - block}}^{E} = {h}_{t , {n}_{E - CNN - block}}^{′ 3 , E} , with$$

$${C}_{3 , E}^{{n}_{E - CNN - block} - 1} < {C}_{1 , E}^{{n}_{E - CNN - block}} = {C}_{2 , E}^{{n}_{E - CNN - block}} > {C}_{3 , E}^{{n}_{E - CNN - block}} , \qquad ( 7 )$$

$${T}_{3 , E}^{{n}_{E - CNN - block} - 1} = {T}_{1 , E}^{{n}_{E - CNN - block}} > {T}_{2 , E}^{{n}_{E - CNN - block}} = {C}_{3 , E}^{{n}_{E - CNN - block}} , and \qquad ( 8 )$$

$${D}_{3 , E}^{{n}_{E - CNN - block} - 1} = {D}_{1 , E}^{{n}_{E - CNN - block}} > {D}_{2 , E}^{{n}_{E - CNN - block}} = {D}_{3 , E}^{{n}_{E - CNN - block}} . \qquad ( 9 )$$

The structure of equation 7 is described in the literature as an inverted bottleneck and helps in learning high-order and strongly expressive features. The time reduction described by equation 8 occurs through having

$${DT}_{{n}_{E - CNN - block}}^{2} > 1 , {DD}_{{n}_{E - CNN - block}}^{m} = 1 , and {DT}_{{n}_{E - CNN - block}}^{\{ 1 , 3 \}} = 1 ,$$

and enables the learning of the mid-term temporal patterns, through the cascaded effect of the dilated convolutions in the

$$CNN - {BE}_{{n}_{E - CNN - block}}^{2} .$$

The effect of equation 9 is achieved by a combination of kernel size, dilation, and stride for each

$$CNN ‐ {BE}_{{n}_{E - CNN - block}}^{2} ,$$

and the effect of the size of kernel

$${KT}_{{n}_{E - CNN - block}}^{2}$$

allows for learning short temporal patterns.

The bottleneck B can comprise two 2D CNN-based blocks and a GRU RNN. A task of the bottleneck B is to completely transform its input dimensionality to feature maps. The bottleneck B then aggregates mid-term to long temporal patterns that are learned through the continuous inputs to the model 200 and creates a starting point for decoding an output prediction. The output of the encoder part E,

$${h}_{t}^{E} ,$$

is given as an input to the bottleneck B, as

$${h}_{t}^{B} = B ( {h}_{t}^{E} ) . \qquad ( 10 )$$

The first CNN block of B is

$${CNNBlock}_{1}^{B} ,$$

is of the type

$$CNNBloc {k}_{{n}_{CNN - blocks}}^{E} ,$$

and has a kernel of

$${KT}_{B 1}^{2} = {T}_{E}^{o u t} and {KD}_{B 2}^{2} = {D}_{E}^{out} ,$$

and unit stride and no padding nor dilation for all m, and process

$${h}_{t}^{E}$$

as

$${h}_{t}^{B 1} = {CNNBlock}_{1}^{B} ( {h}_{t}^{E} ) , \qquad ( 11 )$$

where

$${h}_{t}^{B 1} ∈ {ℝ}^{{C}_{B 1}^{{out}_{\times 1 \times 1}}} , {C}_{B 1}^{out} = {D}_{RNN - E}^{h} , and {CNNBlock}_{1}^{B}$$

is the first CNN block of the bottleneck B. Then,

$${h}_{t}^{B 1}$$

is reshaped to

$${h}_{t}^{B 1} ∈ {ℝ}^{1 \times {D}_{RNN - E}^{h}}$$

and given as an input to the causal GRU \vec{GRU}^{E} along with the input hidden states

$${h}_{t - 1}^{E}$$

as

$${h}_{t}^{′ E} = {\vec{G R U}}^{E} ( {h}_{t}^{B 1} , {h}_{t - 1}^{E} ) , and {h}_{t}^{E} = {h}_{t}^{′ E} + {h}_{t}^{B 1} \qquad ( 12 )$$

where

$${h}_{t}^{′ E} ∈ {[ - 1 , 1 ]}^{1 \times {D}_{RNN - E}^{h}}$$

are the new hidden states of the first GRU and will be used for the calculation of the \vec{GRU}^{E} at the timeframe t+1, and

$${h}_{t}^{E}$$

is reshaped to

$${ℝ}^{{C}_{B 1}^{out} \times 1 \times 1}$$

and will be given as an input to the second CNN block of the bottleneck B. The addition in Eq. 11 is a residual connection for the \vec{GRU}^{E}. This has added benefit to the training process of a GRU. The second CNN block of the bottleneck B is

$$CNNBloc {k}_{2}^{B}$$

and comprises an input processing two-dimensional

$$CNN , CNN - {DI}_{2}^{B} ,$$

with a kernel size

$${KT}_{I}^{2} \times {KD}_{I}^{2} ,$$

unit stride, and no padding, and an upsampling process implemented by a transposed convolution two-dimensional CNN,

$$CNN - {DU}_{2}^{B} ,$$

with a kernel size

$$1 \times {KD}_{U}^{2} ,$$

unit stride, and no padding. Each of the two two-dimensional CNNs is preceded by a dropout functionality with probability

$${pB}_{\{ I \vert U \}}^{2} , {DpB}_{\{ I \vert U \}}^{2} ,$$

and followed by a normalization process,

$${zB}_{\{ I \vert U \}}^{2} ,$$

and a non-linearity

$${gB}_{\{ I \vert U \}}^{2} ,$$

as

$${h}_{t}^{′ B 2} = {gB}_{I}^{2} ( {zB}_{I}^{2} ( CNN - {DI}_{2}^{B} ( {DpB}_{I}^{2} ( {h}_{t}^{E} ) ) ) ) , and \qquad ( 13 )$$

$${h}_{t}^{B 2} = {gB}_{U}^{2} ( {zB}_{U}^{2} ( CNN - {DU}_{2}^{B} ( {DpB}_{U}^{2} ( {h}_{t}^{′ B 2} ) ) ) ) , \qquad ( 14 )$$

where

$${h}_{t}^{B} = {h}_{t}^{B 2} , and {h}_{t}^{B 2} ∈ {ℝ}^{{C}_{E}^{out} \times 1 \times {D}_{E}^{out}} .$$

Although the processing inside the

$${CNNBlock}_{2}^{B}$$

is happening only in the frequency dimension, two-dimensional CNNs are used to speed up training by using a sequence as input. The kernel has a unit size in the time dimension so there is no temporal information leaking between the different time frames.

The decoder part D comprises concatenated N_{D-CNN-blocks}=N_{E-CNN-blocks}−1 CNN blocks,

$${CNNBlock}_{{n}_{D - CNN - block}}^{D} ,$$

of the same type as

$${CNNBlock}_{2}^{B} ,$$

and a GRU-based autoencoder using one GRU RNN, AE-RNN^{D}, and a final two-dimensional CNN, CNN-D. The input to the decoder part D is

$${h}_{t}^{B}$$

as

$${h}_{t}^{D} = D ( {h}_{t}^{B} , {h}_{t , {n}_{E - CNN - block}}^{E} ) , \qquad ( 15 )$$

where

$${h}_{t}^{D} ∈ {ℝ}_{\geq 0}^{1 \times {D}_{P}^{i n}}$$

is the output of the decoder part D. Each

$${CNNBlock}_{{n}_{D - CNN - block}}^{D} ,$$

similarly to

$${CNNBlock}_{2}^{B} ,$$

has an input processing two-dimensional CNN,

$$CNN - {DI}_{{n}_{D - CNN - block}}^{D} ,$$

with a kernel size

$${KT}_{I}^{{n}_{D - CNN - block}} \times {KD}_{I}^{{n}_{D - CNN - block}} ,$$

unit stride, and no padding, and an upsampling process implemented by a transposed convolution 2D CNN,

$$CNN - {DU}_{{n}_{D - CNN - block}}^{D} ,$$

with a kernel size

$$1 \times {KD}_{U}^{{n}_{D - CNN - block}} ,$$

unit stride, and no padding. Each of the two two-dimensional CNNs is preceded by a dropout functionality with probability

$$p {D}_{\{ I \vert U \}}^{{n}_{D - CNN - block}} , Dp {D}_{\{ I \vert U \}}^{{n}_{D - CNN - block}} ,$$

and followed by a normalization process,

$$z {D}_{\{ I \vert U \}}^{{n}_{D - CNN - block}} ,$$

and a non-linearity

$$g {B}_{\{ I \vert U \}}^{{n}_{D - CNN - block}} ,$$

as

$${h}_{t , {n}_{D - CNN - block}}^{′ D} = {gD}_{I}^{{n}_{D - CNN - block}} ( {zD}_{I}^{{n}_{D - CNN - block}} ( \text{} CNN \text{} - {DI}_{{n}_{D - CNN - block}}^{D} ( \text{} {DpD}_{I}^{{n}_{D - CNN - block}} ( \text{} {h}_{t , {n}_{D - CNN - block - 1}}^{D} , {S}_{t , {n}_{D - CNN - block}} ) ) ) \qquad ( 17 )$$

$${h}_{t , {n}_{D - CNN - block}}^{D} = {gD}_{U}^{{n}_{D - CNN - block}} ( {zD}_{U}^{{n}_{D - CNN - block}} ( \text{} CNN \text{} - {DU}_{{n}_{D - CNN - block}}^{D} ( \text{} {DpD}_{U}^{{n}_{D - CNN - block}} ( \text{} {h}_{t , {n}_{D - CNN - block - 1}}^{′D} ) ) ) ) ,$$

where

$${S}_{t , {n}_{D - CNN - block}} = {h}_{t , {n}_{E - CNN - block}^{′}}^{E}$$

with n′_{E-CNN-block}=N_{E-CNN-block}−(n_{D-CNN-block}−1),

$${h}_{t , 0}^{D} = {h}_{t}^{B} , {S}_{t , {n}_{D - CNN - block}} and {h}_{t , {n}_{D - CNN - block} - 1}^{D}$$

and concatenated at the feature dimension, and

$${h}_{t , {N}_{D - CNN - block}}^{D} {ℝ}^{1 \times 1 \times {D}_{P}^{in}} .$$

### The

$${h}_{t , {N}_{D - CNN - block}}^{D}$$

is reshaped into

$${ℝ}^{1 \times {D}_{P}^{in}}$$

and is given as an input to the RNN-based auto-encoder AE-RNN^{D}, which comprises the encoder of the AE-RNN^{D}, a GRU, and the decoder of the AE-RNN^{D}. The encoder of the AE-RNN^{D}, AE-ENC^{D}, comprises a dropout process, a linear layer, and normalization process. The decoder of the AE-RNN^{D}, AE-DEC^{D}, comprises a dropout process and a linear layer. The input to AE-RNN^{D} is processed as

$${h}_{t}^{′ AE - {RNN}^{D}} = AE ‐ {ENC}^{D} ( {h}_{t , {N}_{D - CNN - block}}^{D} ) , \qquad ( 18 )$$

$${h}_{t}^{″ AE - {RNN}^{D}} = {GRU}^{D} ( {h}_{t}^{′ AE - {RNN}^{D}} , {h}_{t - 1}^{D} ) , and \qquad ( 19 )$$

$${h}_{t}^{′′′ AE - {RNN}^{D}} = AE ‐ {DEC}^{D} ( {h}_{t}^{″ AE - {RNN}^{D}} + {h}_{t}^{′ AE - {RNN}^{D}} ) , \qquad ( 20 )$$

where

$${h}_{t}^{″ AE - {RNN}^{D}}$$

will be used as the hidden input to the GRU^{D} for the next timeframe t+1, and

$${h}_{t}^{′′′ AE - {RNN}^{D}}$$

is the output of the AE-RNN^{D}. Finally, the

$${h}_{t}^{′′′ AE - {RNN}^{D}}$$

is reshaped to

$${ℝ}^{1 \times 1 \times {D}_{P}^{in}} ,$$

is concatenated in the feature dimension with

$${h}_{t , 1}^{E}$$

forming

$${h}_{t}^{A E - R N {N}^{D}} ,$$

and the latter is given as an input to the CNN-D, followed by a sigmoid non-linearity, as

$$\hat{{x}_{t}} = CNN - D ( {h}_{t}^{A E - R N {N}^{D}} ) , \qquad ( 21 )$$

predicting the output denoising mask, \hat{x}ₜ.

In the above-described implementation, the following values have been used, but deviations of these values can also be considered:

$${D}_{STFT}^{i n} = 1025 \\ {N}_{frames} = 32 \\ {D}_{P}^{i n} = 96 \\ {D}_{RNN - E}^{h} = 64 \\ {D}_{RNN - D}^{h} = 64 \\ {N}_{E - CNN - blocks} = 6 \\ {C}_{E}^{out} \times {T}_{E}^{out} \times {D}_{E}^{out} = 16 \times 3 \times 7 \\ {KT}_{{n}_{E - CNN - block}}^{\{ 1 \vert 3 \}} \times {KD}_{{n}_{E - CNN - block}}^{\{ 1 \vert 3 \}} = 1 \times 1 \\ {KT}_{1}^{\{ 2 \}} \times {KD}_{1}^{\{ 2 \}} = 3 \times 3 \\ {KT}_{\{ 2 \vert 4 \vert 6 \}}^{\{ 2 \}} \times {KD}_{\{ 2 \vert 4 \vert 6 \}}^{\{ 2 \}} = 3 \times 5 \\ {KT}_{\{ 3 \vert 5 \}}^{\{ 2 \}} \times {KD}_{\{ 3 \vert 5 \}}^{\{ 2 \}} = 3 \times 1 \\ {ST}_{{n}_{E - CNN - block}}^{\{ 1 \vert 3 \}} \times {SD}_{{n}_{E - CNN - block}}^{\{ 1 \vert 3 \}} = 1 \times 1 \\ {ST}_{1}^{\{ 2 \}} \times {SD}_{1}^{\{ 2 \}} = 1 \times 1 \\ {ST}_{\{ 2 \vert 4 \vert 6 \}}^{\{ 2 \}} \times {SD}_{\{ 2 \vert 4 \vert 6 \}}^{\{ 2 \}} = 1 \times 2 \\ {ST}_{\{ 3 \vert 5 \}}^{\{ 2 \}} \times {SD}_{\{ 3 \vert 5 \}}^{\{ 2 \}} = 1 \times 1 \\ {DT}_{{n}_{E - CNN - block}}^{\{ 1 \vert 3 \}} \times {DD}_{{n}_{E - CNN - block}}^{\{ 1 \vert 3 \}} = 1 \times 1 \\ {DT}_{\{ 2 \vert 3 \vert 4 \vert 5 \vert 6 \}}^{\{ 2 \}} \times {DD}_{\{ 2 \vert 3 \vert 4 \vert 5 \vert 6 \}}^{\{ 2 \}} = 3 \times 1$$

Padding of

$${CNNBlock}_{1}^{E}$$

is 2 from the start of the temporal dimension, not 1 at both sides, to maintain causality, and 1 at both sides in frequency dimension. All other

$${CNNBlock}_{{n}_{E - CNN - block}}^{E}$$

have no padding at all.
All dropout probabilities are 0

$${KT}_{I}^{2} \times {KD}_{I}^{2} = 1 \times 1$$

$${KD}_{U}^{2} = 7$$

$${zE}_{{n}_{E - CNN - block}}^{\{ 1 \vert 2 \}} = batchnorm 2 D$$

$${zE}_{{n}_{E - CNN - block}}^{\{ 3 \}} = no normalization$$

$${gE}_{{n}_{E - CNN - block}}^{\{ 1 \vert 2 \}} = Rectified llinear unit ( ReLU )$$

$${gE}_{{n}_{E - CNN - block}}^{\{ 3 \}} = No non - linearity$$

$${zB}_{U}^{2} = batchn orm 2 D$$

$${zB}_{I}^{2} = no normalization \\ {gB}_{\{ I \vert U \}}^{2} = ReLU$$

$${KT}_{I}^{{n}_{D - CNN - block}} \times {KD}_{I}^{{n}_{D - CNN - block}} = 1 \times 1 \\ {KD}_{U}^{\{ 1 \vert 3 \vert 5 \}} = 6 \\ {KD}_{U}^{\{ 2 \vert 4 \}} = 3$$

$${zD}_{\{ I \}}^{{n}_{D - CNN - block}} = no normalization \\ {zD}_{\{ U \}}^{{n}_{D - CNN - block}} = batchnorm 2 D$$

FIG. 17 schematically shows an example temporal storing convolution operator that can be used in models 200 in examples of the disclosure. The temporal storing convolution operator is designed for frame-by-frame processing and also designed so that it efficiently also processes historical data so as to avoid computational redundancy.

The example temporal storing convolution is different to a typical convolutional network. In a typical convolutional network the convolutional network is provided with data that has a temporal dimension. The sequence of convolutional layers in the convolutional network processes the information in the temporal axis, each layer providing the data to the next layers. However, in frame-by-frame processing the straightforward implementation of such a structure is inefficient. For example, if a second convolution operator uses a kernel that is three steps long in the temporal domain, it needs these three temporal frames worth of data from the previous convolution operation. There is an inherent redundancy in the typical convolutional network because the two oldest data elements of the input to the convolutional operator are the same as the two newest data elements in the corresponding input at the previous call of the same convolution operation.

The temporal storing convolution operator reduces this unwanted redundancy. The temporal storing convolution operator receives an input 1700 comprising 1 temporal position. The input 1700 could comprise data from previous layers or from a network input depending on where this instance of the temporal storing convolution operator is implemented. The input 1700 can have more than one position in other axes. For example the input 1700 could have multiple frequency positions and/or multiple feature positions.

The temporal storing convolution operator receives an input 1702 comprising Y−1 temporal positions. This input has the same number of other positions, for example the same number of frequency positions or feature positions. The input 1702 can be obtained from memory storage. The input 1702 can be based on a previous operation of the temporal storing convolution operator.

The temporal storing convolution operator is arranged to perform temporal concatenation 1704 of the input 1702 comprising Y−1 temporal positions and the input 1700 comprising 1 temporal position. The concatenation can be performed in this order. The output of the temporal concatenation 1704 is input data 1706. The input data 1706 has Y temporal positions.

The input data 1706 with Y temporal positions is provided to a conventional convolution 1708. The conventional convolution 1708 has receptive field Y in the temporal dimension. The conventional convolution 1708 processes the input data 1706 with Y temporal positions to obtain output data 1710. The output data 1710 has 1 temporal position. For example, the receptive field of length Y could be due to a kernel that has the temporal dimension Y; or it could be due to using kernel dilations that combine with the kernel size to a temporal dimension Y. For example, a kernel that has a temporal size of 3, but two temporal steps of dilation in between each of these elements, would have the receptive field of Y=7. This conventional convolution 1708 does not use any padding. The output data 1710 is then provided to the next layers and/or network output, depending on where in the network the present instance of the temporal storing convolution is implemented.

The input data 1706 with Y temporal positions is also provided as an input to a discard 1 step block 1712. The discard 1 step block 1712 is arranged to discard the oldest temporal position data. The discard 1 step block 1712 is arranged to discard the oldest temporal position of data, and outputs the remaining data 1714. The remaining data 1714 is as data with (Y−1) temporal positions. This remaining data 1714 is stored to the memory to be used when the network utilizing the same instance of the temporal storing convolution is called next time, when the next step of obtained temporal data is to be processed.

A complete model that uses one or more of these temporal storing convolutions would save the (Y−1) length data for each of these instances, to be used, in each of them, at the next network call with new data. The receptive field Y can be same or different for each of the used temporal storing convolution blocks.

FIG. 18 schematically illustrates an apparatus 1800 that can be used to implement examples of the disclosure. In this example the apparatus 1800 comprises one or more controllers 1802. The one or more controllers 1802 can be a chip or a chip-set or circuitry or any combination thereof. In some examples the controller 1802 can be provided within a user device, such as the user devices 102, the peripheral playback devices 108, or server devices or any other suitable devices within a communication system 100 such as the system 100 shown in FIG. 1.

In the example of FIG. 18 the implementation of the controller 1802 can be as controller circuitry. In some examples the controller 1802 can be implemented in hardware alone, have certain aspects in software including firmware alone or can be a combination of hardware and software (including firmware).

As illustrated in FIG. 18 the controller 1802 can be implemented using instructions that enable hardware functionality, for example, by using executable instructions of one or more computer programs 1808 in one or more general-purpose or special-purpose processors 1804 that can be stored on one or more computer readable storage mediums 1806, 1812 (disk, memory etc.) to be executed by such one or more processors 1804.

The processor 1804 is configured to read from and write to the memory 1806. The processor 1804 can also comprise an output interface via which data and/or commands are output by the processor 1804 and an input interface via which data and/or commands are input to the processor 1804.

The memory 1806 is configured to store a computer program 1808 comprising computer program instructions (computer program code 1810) that controls the operation of the controller 1802 when loaded into the processor 1804. The computer program instructions, of the computer program 1808, provide the logic and routines that enables the controller 1802 to perform the methods illustrated in the Figs. The processor 1804 by reading the memory 1806 is able to load and execute the computer program 1808.

The apparatus 1800 therefore comprises: at least one processor 1804; and at least one memory 1806 including computer program code 1810, the at least one memory storing instructions that when executed by the at least one processor 1804, cause the apparatus 1800 at least to perform:
receiving 500 input data where the input data is based on a current frame of a noisy speech signal and one or more past frames of a noisy speech signal and the input data comprises data elements corresponding to multiple frequency positions and multiple temporal positions;
encoding 502 the input data using a sequence of encoding layers to provide output data of the encoding comprising a reduced number of frequency positions and a single temporal position;
decoding 504 the output data of the encoding using a sequence of decoding layers caused to receive data from a prior decoding layer, wherein at least one of the decoding layers is configured to receive data from a prior decoding layer and an encoding layer, to provide output data of the decoding, and wherein the output data of the decoding comprises multiple frequency positions and a single temporal position; and
processing 506 the output data of the decoding to provide an output signal for speech enhancement.

As illustrated in FIG. 18 the computer program 1808 can arrive at the controller 1800 via any suitable delivery mechanism 1812. The delivery mechanism 1812 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 1808. The delivery mechanism 1812 can be a signal configured to reliably transfer the computer program 1808. The controller 1802 can propagate or transmit the computer program 1808 as a computer data signal. In some examples the computer program 1808 can be transmitted to the controller 1802 using a wireless protocol such as Bluetooth, Bluetooth Low Energy, Bluetooth Smart, 6LoWPan (IPv6 over low power personal area networks) ZigBee, ANT+, near field communication (NFC), Radio frequency identification, wireless local area network (wireless LAN) or any other suitable protocol.

The computer program 1808 comprises computer program instructions that when executed by an apparatus 1800 cause the apparatus 1800 to perform at least the following:
receiving 500 input data where the input data is based on a current frame of a noisy speech signal and one or more past frames of a noisy speech signal and the input data comprises data elements corresponding to multiple frequency positions and multiple temporal positions;
encoding 502 the input data using a sequence of encoding layers to provide output data of the encoding comprising a reduced number of frequency positions and a single temporal position;
decoding 504 the output data of the encoding using a sequence of decoding layers caused to receive data from a prior decoding layer, wherein at least one of the decoding layers is configured to receive data from a prior decoding layer and an encoding layer, to provide output data of the decoding, and wherein the output data of the decoding comprises multiple frequency positions and a single temporal position; and
processing 506 the output data of the decoding to provide an output signal for speech enhancement.

The computer program instructions can be comprised in a computer program 1808, a non-transitory computer readable medium, a computer program product, a machine readable medium. In some but not necessarily all examples, the computer program instructions can be distributed over more than one computer program 1808.

Although the memory 1806 is illustrated as a single component/circuitry it can be implemented as one or more separate components/circuitry some or all of which can be integrated/removable and/or can provide permanent/semi-permanent/dynamic/cached storage.

Although the processor 1804 is illustrated as a single component/circuitry it can be implemented as one or more separate components/circuitry some or all of which can be integrated/removable. The processor 1804 can be a single core or multi-core processor.

In some other implementations, the playback device 108 can comprise the same communication and computational means as the device 102. In some other or additional implementation the playback device 108 can have one or more microphones and/or one or more loudspeakers which are connected to the device 102 for processing.

In some other or additional implementations the user device 102 and the playback device 108 can share computational means.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific integrated circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software can not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The apparatus 1800 as shown in FIG. 18 can be provided within any suitable device. In some examples the apparatus 1800 can be provided within an electronic device such as a mobile telephone, a teleconferencing device, a camera, a computing device, a server or any other suitable device.

The blocks illustrated in the Figs. can represent steps in a method and/or sections of code in the computer program 1808. The illustration of a particular order to the blocks does not necessarily imply that there is a required or preferred order for the blocks and the order and arrangement of the blocks can be varied. Furthermore, it can be possible for some blocks to be omitted.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS (Global Positioning System) devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to A comprising B indicates that A may comprise only one B or may comprise more than one B. If it is intended to use ‘comprise’ with an exclusive meaning then it will be made clear in the context by referring to ‘comprising only one . . . ’ or by using ‘consisting.’

In this description, the wording ‘connect’, ‘couple’ and ‘communication’ and their derivatives mean operationally connected/coupled/in communication. It should be appreciated that any number or combination of intervening components can exist (including no intervening components), i.e., to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database, or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’, or ‘may’ refers to a particular instance in a class of examples. A property of the instance can be a property of only that instance or a property of the class or a property of a sub-class of the class that includes some but not all the instances in the class. It is therefore implicitly disclosed that a feature described with reference to one example but not with reference to another example, can where possible be used in that other example as part of a working combination but does not necessarily have to be used in that other example.

As used herein, “at least one of the following:” and “at least one of” and similar wording, where the list of two or more elements are joined by “and” or “or” mean at least any one of the elements, or at least any two or more of the elements, or at least all the elements.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

The description of a feature, such as an apparatus or a component of an apparatus, configured to perform a function, or for performing a function, should additionally be considered to also disclose a method of performing that function. For example, description of an apparatus configured to perform one or more actions, or for performing one or more actions, should additionally be considered to disclose a method of performing those one or more actions with or without the apparatus.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and to features that achieve substantially the same technical effect (equivalent features). The equivalent features include, for example, features that are variants and achieve substantially the same result in substantially the same way.

The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance the Applicant may seek protection via the claims in respect of any patentable feature or combination of features hereinbefore referred to and/or shown in the drawings whether or not emphasis has been placed thereon.

1. A model for speech enhancement comprising:
an encoder part comprising a sequence of encoding layers wherein the encoder part is caused to receive input data where the input data is based on a current frame of a noisy speech signal and one or more past frames of the noisy speech signal and the input data comprises data elements corresponding to multiple frequency positions and multiple temporal positions, wherein the sequence of encoding layers is caused to process the input data so that output data of the encoder part comprises a reduced number of the multiple frequency positions and a single temporal position;
a decoder part comprising a sequence of decoding layers caused to receive data from a prior decoding layer, wherein at least one of the decoding layers is caused to receive data from a prior decoding layer and an encoding layer, and wherein the sequence of decoding layers is caused to process the received data so that the output data of the decoder part comprises multiple frequency positions and a single temporal position; and
wherein the output data of the decoder part is for post processing to provide an output signal for speech enhancement.

2. A model as claimed in claim 1 comprising one or more skip connections caused to relay skip connection signals from respective encoding layers to corresponding decoding layers to enable at least one of the decoding layers to receive data from a respective encoding layer.

3. A model as claimed in claim 2 wherein the skip connection signals comprise a single temporal position.

4. A model as claimed in claim 2 wherein the decoding layers of the decoder part comprise operations to combine data from a skip connection signal with received data from a prior decoding layer and operations to increase the multiple frequency positions of the combined data.

5. A model as claimed in claim 2 wherein the decoding layers of the decoder part comprise operations to combine data from a skip connection signal with received data from a prior decoding layer and a linear interpolation process and operations caused to increase the frequency positions of the combined data.

6. A model as claimed in claim 1 wherein the sequence of decoding layers is caused to process the received data so that the output data of the decoder part comprises the same number of frequency positions as the input data for the encoder part and a single temporal position.

7. A model as claimed in claim 1 wherein the encoding layers of the encoder part comprise convolutional operations.

8. A model as claimed in claim 1 wherein at least one of the encoding layers uses a kernel comprising multiple temporal components to process data elements corresponding to more than one temporal position.

9. A model as claimed in claim 8 wherein at least one of the encoding layers uses a kernel that uses dilation in a temporal dimension.

10. A model as claimed in claim 1 comprising an input layer caused to generate the input data based on the current frame and to store the input data based on past frames.

11. A model as claimed in claim 1 comprising a bottleneck comprising one or more layers caused to process the output data of the encoder part into bottleneck output data that comprises a single temporal position; and the decoder part is configured to receive and process the bottleneck output data.

12. A model as claimed in claim 11 wherein the bottleneck comprises a recurrent neural network layer.

13. A model as claimed in claim 1 wherein the post processing is performed by a post processing part and wherein the post processing part is one of:
part of the model; or
outside of the model.

14. A model as claimed in claim 1 wherein the post processing part comprises one or more layers caused to process the output data of the decoder part to provide an output signal for the speech enhancement.

15. A model as claimed in claim 13 wherein the post processing part comprises a recurrent layer caused to process the output data of the decoder part to provide at least one of an output mask for the speech enhancement or an enhanced speech signal.

16. A model as claimed in claim 1 wherein the speech enhancement comprises at least one of:
denoising;
echo suppression;
de-reverberation;
speech bandwidth expansion;
packet loss concealment improvement;
wind noise removal;
recovery of missing speech signal;
residual echo suppression;
jet engine noise removal; or
non-linear distortion removal.

17. An apparatus comprising:
at least one processor; and
at least one memory storing instruction that, when executed by the at least one processor, cause the apparatus at least to:
receive input data where the input data is based on a current frame of a noisy speech signal and one or more past frames of a noisy speech signal and the input data comprises data elements corresponding to multiple frequency positions and multiple temporal positions;
encode the input data using a sequence of encoding layers to provide output data of the encoding comprising a reduced number of frequency positions and a single temporal position;
decode the output data of the encoding using a sequence of decoding layers caused to receive data from a prior decoding layer, wherein at least one of the decoding layers is configured to receive data from a prior decoding layer and an encoding layer, to provide output data of the decoding, and wherein the output data of the decoding comprises multiple frequency positions and a single temporal position; and
process the output data of the decoding to provide an output signal for speech enhancement.

18. An apparatus as claimed in claim 17, further comprising one or more skip connections caused to relay skip connection signals from respective encoding layers to corresponding decoding layers to enable at least one of the decoding layers to receive data from a respective encoding layer.

19. An apparatus as claimed in claim 18, wherein the sequence of decoding layers is further caused to process the received data so that the output data of the decoder part comprises the same number of frequency positions as the input data for the encoder part and a single temporal position.

20. A method comprising:
receiving input data where the input data is based on a current frame of a noisy speech signal and one or more past frames of a noisy speech signal and the input data comprises data elements corresponding to multiple frequency positions and multiple temporal positions;
encoding the input data using a sequence of encoding layers to provide output data of the encoding comprising a reduced number of frequency positions and a single temporal position;
decoding the output data of the encoding using a sequence of decoding layers caused to receive data from a prior decoding layer, wherein at least one of the decoding layers is configured to receive data from a prior decoding layer and an encoding layer, to provide output data of the decoding, and wherein the output data of the decoding comprises multiple frequency positions and a single temporal position; and
processing the output data of the decoding to provide an output signal for speech enhancement.
